(19) United States
(12) Patent Application Publication
(10) Pub. No.: US 2007/0186424 A1
(43) Pub. Date: Aug. 16, 2007

(54) Multi-layer coating for razor blades

(75) Inventors: Sandra Becker, Solingen (DE); Scott Camphausen, Milford, CT (US); Randy Nicolosi, Shelton, CT (US); Jochen Thoene, Wuppertal (DE); Matthias Niggemann, Wuppertal (DE)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/704,541

(22) Filed: Feb. 9, 2007

Related U.S. Application Data
(60) Provisional application No. 60/772,379, filed on Feb. 10, 2006.

(51) Int. Cl. B26B 29/00

(52) U.S. Cl. 30/294

(57) ABSTRACT

A razor blade is provided that includes a substrate with a cutting edge defined by a sharpened tip and an adjacent facet, a layer of titanium containing material on the cutting edge, a layer of hard carbon material on the titanium containing layer, and an outer layer of polytetrafluoroethylene.

### CROSS-REFERENCE TO RELATED APPLICATION

This application claims the benefit of U.S. Provisional Patent Application Ser. No. 60/772,379 filed Feb. 10, 2006, which is hereby incorporated herein in its entirety.

### BACKGROUND OF THE INVENTION

1. Technical Field

This invention relates generally to shaving devices, and more specifically to razor blades having multi-layer coatings.

2. Background Information

A razor blade is typically formed of a suitable substrate material, such as stainless steel. A cutting edge is provided to the razor blade, typically by grinding and honing. The cutting edge has a wedge-shaped configuration with a sharpened tip having a radius less than about 1000 angstroms, e.g., about 200-500 Angstroms. Hard carbon coatings such as amorphous diamond or diamond-like carbon (DLC) material are often used to improve hardness, strength, corrosion resistance and shaving ability. The hard carbon coating maintains the required strength of the ultimate tip while permitting more acutely angled wedge shapes with consequently lower cutting forces to be used. A polytetrafluoroethylene (PTFE) outer layer can be used to provide friction reduction. The adhesion of a hard carbon material such as amorphous diamond or DLC to a stainless steel substrate can be promoted by providing an undercoat layer of an adhesion promoting material between the substrate and the hard carbon layer. It is known in the art to provide a layer of chromium or niobium containing materials as an adhesion promoting layer. This is described in U.S. Pat. No. 6,684,513 to Clipstone et al. In practice, a magnetron target (as will be discussed later in the instant application) to provide a niobium layer costs about 50% more than a target for a chromium layer and is consequently not preferred for reasons of manufacturing cost. The use of chromium is well known in the art, it promotes adequate adhesion and it provides a good solution to this problem.

Under extreme shaving conditions, the sharpened tip of the razor blade can undergo small elastic deformations. If the sharpened tip has a hard coating, these deformations can result in micro cracks in the outer surface of the hard coating. If the hard coating is intimately bonded to the substrate or to an undercoat, which is in turn intimately bonded to the substrate, the crack in the hard coating can propagate through to the substrate resulting in premature failure of the sharpened tip of the razor blade. This can result in an unpleasant shaving experience. Titanium is tougher and more elastic than chromium and can advantageously act to arrest the propagation of micro cracks into the substrate. Some comparative pertinent properties of titanium and chromium are listed in the following table:

| | | |
|---|---|---|
| Property | Titanium | Chromium |

| | | | | |
|---|---|---|---|---|
| Tensile Modulus (GPa) | 116 | approx | 279 | approx |
| Poisson's ratio | 0.32 | approx | 0.21 | approx |
| Hardness (Hv) | 970 | approx | 1060 | approx |

Based on the foregoing, it is the object of the present invention to provide a cutting edge of a razor blade with a layer of a titanium containing material as an adhesion promoter for a subsequent layer of a hard carbon containing material.

### SUMMARY OF THE INVENTION

In one aspect, the invention features, in general, a razor blade including a substrate with a cutting edge defined by a sharpened tip and adjacent facets. A layer of titanium containing material is on the cutting edge. A layer of hard carbon material is coated on the titanium containing material and an outer layer of PTFE is provided. The titanium containing material may include titanium or one or more compounds selected from: titanium alloyed with a carbide forming metal, titanium aluminum nitride, titanium oxide, titanium carbide, titanium carbonitride and titanium nitride. The titanium containing material may further include a composition of titanium with any one of the aforementioned materials. The layer of titanium containing material can be at least 50 Angstroms thick. The hard carbon material may be diamond-like carbon (DLC) or amorphous diamond and can be less than 2000 Angstroms thick. The PTFE can be DRYFILM LW1200 available from DUPONT.

In another aspect, the invention features, in general, a safety razor including a handle and a housing that includes at least one razor blade, supra. The housing can also include at least four razor blades, supra.

In a further aspect, the invention features, in general, a method of making a razor blade by providing a substrate with a cutting edge defined by a sharpened tip and adjacent facets. A layer of titanium containing material is applied to the cutting edge by a physical vapor deposition (PVD) process. The PVD process can be a sputtering process or a cathodic arc deposition process. A layer of hard carbon material is coated on the titanium containing material. An outer layer of PTFE is provided. A sputtering process to deposit the titanium containing material may include two stages. In a first stage, at least a first bias voltage more positive than −700 volts is applied to the razor blade and the razor blade is in a first atmosphere that includes Argon at a pressure less than 50 milliTorr. In a second stage the titanium containing material is implanted with carbon to form a partial titanium carbide layer. In this second stage the razor blade is in a second atmosphere that includes Argon at a pressure less than 30 milliTorr. In this second stage a second bias voltage more positive than −1500 volts is applied to the razor blade. Subsequent layers of hard carbon material and PTFE are applied by well known processes.

Embodiments of the invention may include one or more of the following advantages. The use of a titanium containing material on the cutting edge of a razor blade promotes adhesion of the hard carbon material. The cutting edge of the razor blade has improved resistance to failure by crack propagation. The razor blade has excellent shaving characteristics.

The above features and advantages of the present invention will be more fully understood with reference to the following detailed description when taken in conjunction with the accompanying drawings.

### BRIEF DESCRIPTION OF THE DRAWINGS

FIG. 1 is a sectional view of a cutting edge portion of a razor blade of the present invention.

FIG. 2 is a front isometric view from above of a safety razor of the present invention.

### DETAILED DESCRIPTION OF A PARTICULAR EMBODIMENT

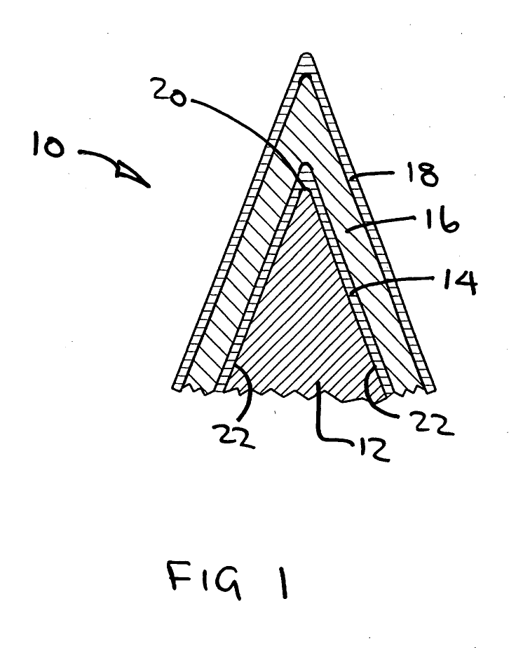

Referring to now to the drawings, and in particular FIG. 1, the cutting edge portion of a razor blade 10 comprises a substrate 12, a layer of titanium containing material 14, a layer of hard carbon material 16 and an outer layer of polytetrafluoroethylene (PTFE) 18. The substrate 12 is typically made of stainless steel, although other substrates such as an amorphous alloy, a carbon steel or a ceramic material can be employed. A preferable stainless steel is disclosed in U.S. Pat. No. 5,275,672 to Althaus et al and is most preferably the grade designated GIN 7 manufactured by HITACHI. One of skill in the art will understand that other stainless steel materials may be used. The substrate is typically supplied in an annealed state as an elongated flat strip, wound in a coil and is preferably 0.05 mm to 0.1 mm thick, most preferably 0.1 mm, and is preferably about 3 mm wide but can be from about 2 mm to 23 mm wide. The substrate may be perforated as is known in the art. The substrate is hardened, again as is known in the art to a hardness about 900 on the Vickers scale (Hv). The substrate is sharpened to provide a cutting edge having a sharpened tip 20 of radius less than 1000 Angstroms and preferably 200-500 Angstroms. The sharpened tip has adjacent facets 22 having an included angle less than 30 degrees and preferably about 15-20 degrees measured 40 microns from the sharpened tip. The sharpening process includes grinding and honing stages and may include a further stropping stage. The sharpening process may be performed on both edges of the elongate substrate but is preferably on one edge only. As the elongate substrate exits the sharpening process it may be cut into individual razor blades and stacked one on the other, or preferably the elongate substrate is recoiled on to a carrier with the sharpened edge facing outward. The substrate is subsequently cleaned by any one of a number of processes known in the art to remove residues from the sharpening process and other contamination. Samples of the substrate are analyzed for cleanliness preferably by a photoelectron emission technique. Suitable measuring equipment is supplied by PET PHOTO EMISSION TECHNOLOGY and is designated SQM300. A substrate with an OSEE (optically stimulated electron emission) value at least 450 is adequately clean.

At least one carrier with recoiled substrate is loaded vertically (that is, with the axis of its coils horizontal) within a vacuum chamber. The vacuum chamber includes a target preferably comprising titanium, and two cathodic arc sources. The target may also comprise titanium alloyed with any carbide forming metal that comprises at least 51% titanium by atomic percent. Suitable process equipment including a vacuum chamber is manufactured by IONBOND. The vacuum chamber may alternately be constructed to have one or more stacks of razor blades loaded therein.

The process steps performed within the vacuum chamber are as follows:

In a first step, the vacuum chamber is sealed and evacuated to about 20 microTorr and a rate of rise test performed to ensure the chamber has no vacuum leaks.

The following glow discharge step removes minor contamination that might remain on the cutting edges. Oxygen is introduced into the chamber to a pressure of 15 to 45 milliTorr. A bias voltage of −500 Volts is applied to the substrate and this is increased to −1000 Volts and held for about 2 minutes. In all process steps herein where a bias voltage is cited, this is preferably a pulsed square wave, pulsed from 0 Volts to the specified bias voltage at 25 kHz and a duty cycle of 62%. Other wave forms and frequencies may be employed. One of skill in the art will understand that the hard carbon material, infra, is a semi-conductor and requires a pulsed DC bias rather than a pure DC bias to avoid creating a static charge on the substrate. The oxygen supply is closed and argon is introduced into the chamber while the substrate is held at about −1000 Volts. The vacuum chamber is then evacuated to 50 microTorr.

The glow discharge step is followed by a magnetron sputtering step that cleans the surface of the target and subsequently deposits the titanium containing material on the cutting edges. A shutter is closed which masks the target. Argon is introduced into the chamber to a pressure of 2 to 20 milliTorr. The power on the target is set to a power density of about 14 W/cm² to 28 W/cm². These conditions are held for 1-3 minutes as a pre-sputter step to clean the surface of the target. The shutter is then opened, exposing the target to the cutting edges so that the titanium containing material may be deposited on the cutting edges. A high bias voltage of −200 to −700 Volts, preferably about −500 Volts, is applied to the substrate for about one minute. This high bias step is necessary to achieve adequate bonding of the titanium containing material to the sharpened tip of the cutting edge. The bias voltage is then reduced to a low bias setting of −20 to −60 volts for about 2 to 5 minutes. A minimum thickness of titanium containing material of 50 Angstroms is deposited on the cutting edge.

The magnetron sputtering step is followed by a preferred a-Diamond or amorphous diamond step that deposits a hard carbon material of amorphous diamond on the titanium containing material. The hard carbon material may also be Diamond-like Carbon (DLC). Two cathodic arc sources are preferably situated such that each carbon beam is approximately normal to one of each facet of the cutting edge. This is the optimum arrangement that will provide hardest coating. Suitable coatings however are achieved with a narrower angle of about 60 degrees between the two carbon beams. Argon is introduced into the chamber to a pressure of 20 microTorr to 9 milliTorr. The cathodic arc sources are set at about 50 to 65 Amps with an initial bias voltage of about −500 to −1000 Volts applied to the substrate. The initial phase of this a-Diamond step implants carbon in the titanium containing material layer to form a partial titanium carbide layer. This partial carbide layer is necessary to ensure adequate adhesion of the hard carbon material to the titanium containing material layer. This step is continued to deposit a hard carbon layer 200 to 1500 Angstroms thick, with a preferred thickness of 200 to 800 Angstroms.

The vacuum chamber is vented and the substrate removed. In a subsequent process, well known to one of skill in the art, an outer layer of polytetrafluoroethylene (PTFE) is deposited. A suitable PTFE is DRYFILM LW1200 manufactured by DUPONT, having a molecular weight of about 40,000. The DRYFILM LW1200 is preferably diluted with alcohol as disclosed in U.S. Patent Application Ser. No. 60/741,144, hereby incorporated in its entirety by reference. One of skill in the art will understand other PTFE materials may be employed.

A razor blade 10 is manufactured generally to the processes described herein. Individual razor blades may be in stack form or the coiled substrate may subsequently uncoiled and cut to a convenient length to form a single razor blade.

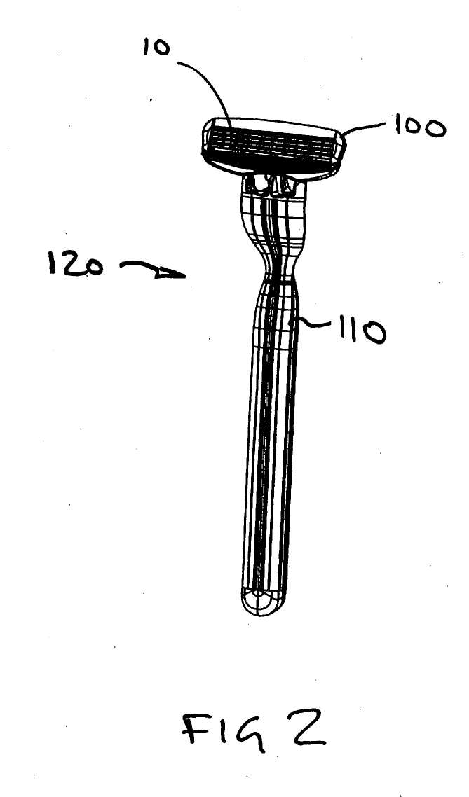

Referring now to FIG. 2, at least one razor blade is mounted in a housing 100. The housing, with its razor blade or blades is selectively connected to a handle 110 to provide a safety razor 120. The housing may contain one, two or three razor blades but preferably at least four. The housing may be permanently or removably connected to the handle.

In use, the cutting edge portion of the razor blade 10 has improved resistance to failure by crack propagation compared to known cutting edges of razor blades having chromium coatings between their substrate and hard carbon coatings. The use of a titanium containing material on the cutting edge of a razor blade promotes adhesion of the hard carbon material. The razor blade has excellent shaving characteristics.

It is to be understood that the present invention is by no means limited to the particular construction herein disclosed and/or shown in the drawings, but also comprises any modifications or equivalents within the scope of the disclosure.

What is claimed is:

1. A razor blade, comprising:
a substrate with a cutting edge defined by a sharpened tip and adjacent facets,
a layer of titanium containing material on the cutting edge,
a layer of hard carbon material on the titanium containing material layer, and
an outer layer of polytetrafluoroethylene.

2. A razor blade according to claim 1, wherein the titanium containing material comprises a material selected from the group consisting of titanium, titanium alloyed with a carbide forming metal, titanium aluminum nitride, titanium oxide, titanium carbide, titanium carbonitride and titanium nitride.

3. A razor blade according to claim 2, wherein the titanium containing material comprises a compound of titanium and at least one material selected from the group consisting of, titanium alloyed with a carbide forming metal, titanium aluminum nitride, titanium oxide, titanium carbide, titanium carbonitride and titanium nitride.

4. A razor blade according to claim 3, wherein the titanium alloyed with a carbide forming metal contains at least 51% titanium by atomic percent.

5. A razor blade according to claim 1, wherein the hard carbon material is selected from the group consisting of diamond-like carbon and amorphous diamond.

6. A razor blade according to claim 1, wherein the polytetrafluoroethylene has a molecular weight of about 40,000.

7. A razor blade according to claim 1, wherein the polytetrafluoroethylene layer is on the layer of hard carbon material.

8. A razor blade according to claim 3, wherein the layer of titanium containing material has a thickness at least 50 Angstroms.

9. A razor blade according to claim 5, wherein the layer of hard carbon material has a thickness less than 2,000 angstroms.

10. A razor blade according to claim 9, wherein the layer of hard carbon material has a thickness between 200 and 800 Angstroms.

11. A safety razor, comprising:
a handle,
a housing connected to the handle, and
at least one razor blade mounted in the housing, the razor blade comprising a substrate with a cutting edge defined by a sharpened tip and adjacent facets,
a layer of titanium containing material on the cutting edge,
a layer of hard carbon material on the titanium containing material layer, and
an outer layer of polytetrafluoroethylene.

12. A safety razor according to claim 11, wherein the titanium containing material comprises a material selected from the group consisting of titanium, titanium alloyed with a carbide forming metal, titanium aluminum nitride, titanium oxide, titanium carbide, titanium carbonitride and titanium nitride.

13. A safety razor according to claim 12, wherein the titanium containing material comprises a compound of titanium and at least one material selected from the group consisting of, titanium alloyed with a carbide forming metal, titanium aluminum nitride, titanium oxide, titanium carbide, titanium carbonitride and titanium nitride.

14. A safety razor according to claim 13, wherein the titanium alloyed with a carbide forming metal contains at least 51% titanium by atomic percent.

15. A safety razor according to claim 11, wherein the hard carbon material is selected from the group consisting of diamond-like carbon and amorphous diamond.

16. A safety razor according to claim 10, wherein the polytetrafluoroethylene has a molecular weight of about 40,000.

17. A safety razor according to claim 11, wherein the polytetrafluoroethylene layer is on the layer of hard carbon material.

18. A safety razor according to claim 13, wherein the layer of titanium containing material has a thickness at least 50 Angstroms.

19. A safety razor according to claim 15, wherein the layer of hard carbon material has a thickness less than 2,000 angstroms.

20. A safety razor according to claim 19, wherein the layer of hard carbon material has a thickness between 200 and 800 Angstroms.

21. A safety razor according to claim 11, wherein the at least one razor blade is at least four razor blades.

22. A method of making a razor blade, comprising:
providing a substrate with a cutting edge defined by a sharpened tip and adjacent facets, adding a layer of titanium containing material to the cutting edge, adding a layer of hard carbon material to the titanium containing material layer, and adding an outer layer of polytetrafluoroethylene.

23. A method according to claim 22, wherein the layer of titanium containing material includes depositing the titanium containing material layer by a physical vapor deposition process.

24. A method according to claim 23, wherein the physical vapor deposition process is a sputtering process.

25. A method according to claim 24, wherein the sputtering process is performed in a chamber that includes a target that comprises titanium.

26. A method according to claim 25, wherein the sputtering process includes applying at least a first bias voltage more positive than −700 volts to the razor blade.

27. A method according to claim 26, wherein the sputtering process is performed in a first atmosphere comprising Argon.

28. A method according to claim 27, wherein the first atmosphere has a pressure less than 50 milliTorr.

29. A method according to claim 28, wherein the first atmosphere has a pressure between 2 and 20 milliTorr.

30. A method according to claim 29, wherein the titanium containing material layer is implanted with carbon to form a partial titanium carbide layer.

31. A method according to claim 30, wherein the implanting is performed in second atmosphere comprising Argon.

32. A method according to claim 31, wherein the second atmosphere has a pressure less than 30 milliTorr.

33. A method according to claim 32, wherein the second atmosphere has a pressure between 0.02 and 9 milliTorr.

34. A method according to claim 30, wherein the implanting is performed with a second bias voltage more positive than −1500 volts applied to the razor blade.
